(19) United States
(12) Patent Application Publication
(10) Pub. No.: US 2021/0356063 A1
(43) Pub. Date: Nov. 18, 2021

(54) Pipe Locking Connection Structure

(71) Applicant: Delsun Co., Ltd., Tainan City (TW)

(72) Inventor: Feng-Jung Lo, Tainan City (TW)

(21) Appl. No.: 15/930,557

(22) Filed: May 13, 2020

(51) Int. Cl. F16L 37/244

(52) U.S. Cl. CPC F16L 37/244

(57) ABSTRACT

A pipe locking connection structure includes a male pipe and a female pipe connected with the male pipe. The male pipe has an outside provided with a slideway and a locking groove. The locking groove is connected to the slideway. An angle is defined between the slideway and the locking groove. The female pipe has an inside provided with a projection. The female pipe is mounted on the male pipe, and the projection is inserted through the slideway until the projection aligns with the locking groove. Then, the female pipe is rotated relative to the male pipe, such that the projection is inserted into and locked in the locking groove. Thus, the female pipe is locked onto the male pipe.

### BACKGROUND OF THE INVENTION

### 1. Field of the Invention

The present invention relates to a combination tool and, more particularly, to a pipe locking connection structure.

### 2. Description of the Related Art

A conventional pipe connection structure comprises multiple pipes connected together. Preferably, each of the pipes is formed with screw holes, and screws are screwed into the screw holes such that the pipes are securely connected by the screws. However, it is necessary to provide a screwdriver to operate the screws, thereby causing inconvenience to the user. In addition, it is time consuming to screw or unscrew the screws in assembly or disassembly of the pipe connection structure. Alternatively, each of the pipes is formed with threaded sections, and the threaded sections engage each other such that the pipes are securely connected. The conventional pipe connection structure is available for a coat hanger, a rack, an article shelf or a handle for a sweeping tool. However, it is also time consuming to threadedly connect or disconnect the pipes in assembly or disassembly of the pipe connection structure.

### BRIEF SUMMARY OF THE INVENTION

The primary objective of the present invention is to provide a pipe locking connection structure that does not need a tool and is assembled rapidly to save the operator's time.

In accordance with the present invention, there is provided a pipe locking connection structure comprising a male pipe and a female pipe connected with the male pipe. The male pipe includes a male pipe body. The male pipe body has an outside provided with a slideway and a locking groove. The slideway extends from one end toward the other end of the male pipe body. The locking groove is connected to a distal end of the slideway. An angle is defined between the slideway and the locking groove. The female pipe includes a female pipe body. The female pipe body has an inside provided with a projection. The female pipe body is mounted on the male pipe body, and the projection is inserted through the slideway and is locked into the locking groove.

In assembly, when the female pipe is mounted on the male pipe, the female pipe body is mounted on the male pipe body, with the projection aligning with the slideway. Then, the projection is inserted through the slideway until the projection aligns with the locking groove. Then, the female pipe is rotated relative to the male pipe, and the female pipe body is rotated toward the locking groove, such that the projection is inserted into and locked in the locking groove. Thus, the female pipe is locked onto and affixed to the male pipe.

On the contrary, the female pipe is rotated relative to the male pipe in the opposite direction, such that the projection is moved from the locking groove to the slideway. Then, the female pipe body is pulled outward relative to the male pipe body, and the projection is moved in the slideway, such that the female pipe is detached from the male pipe.

According to the primary advantage of the present invention, the male pipe and the female pipe are assembled and disassembled easily and conveniently without needing aid of any hand tool. In addition, the male pipe and the female pipe are securely connected and detached simply and quickly. Further, the pipe locking connection structure is available for a coat hanger or an article shelf.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is an exploded perspective view of a pipe locking connection structure in accordance with the preferred embodiment of the present invention.

FIG. 2 is a cross-sectional view of the pipe locking connection structure as shown in FIG. 1.

FIG. 3 is a cross-sectional operational assembly view of the pipe locking connection structure as shown in FIG. 2.

FIG. 4 is a cross-sectional operational view of the pipe locking connection structure as shown in FIG. 3.

FIG. 5 is a partially perspective assembly view of the pipe locking connection structure in accordance with the preferred embodiment of the present invention.

### DETAILED DESCRIPTION OF THE INVENTION

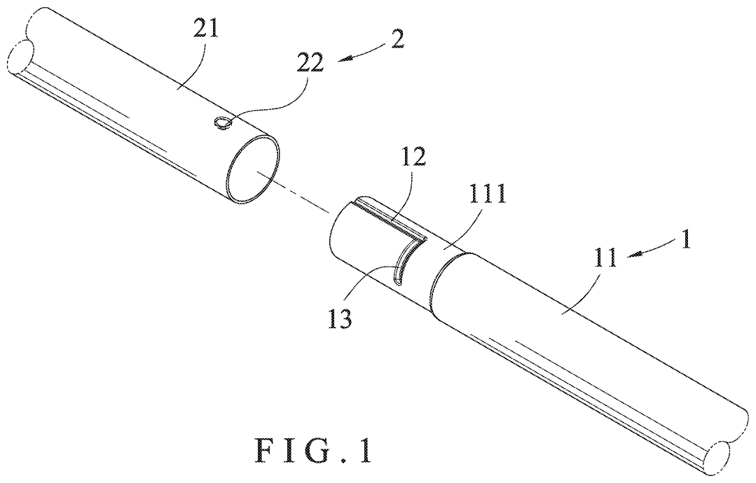

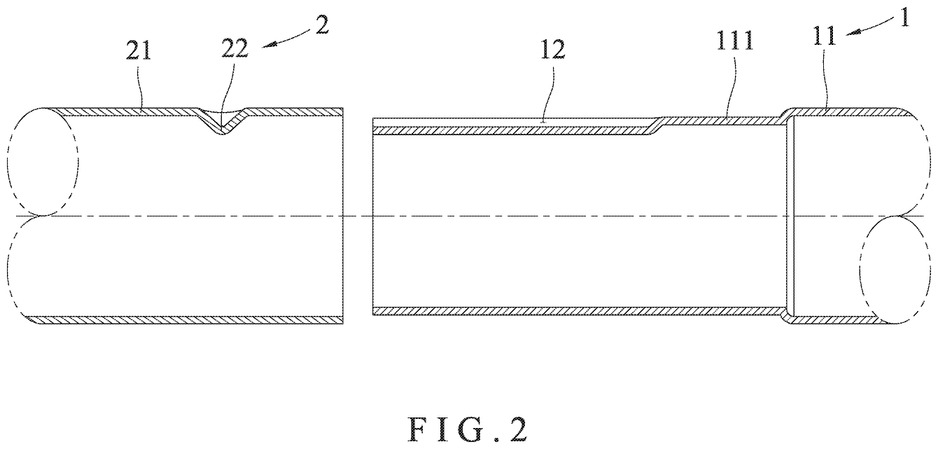

Referring to the drawings and initially to FIGS. 1 and 2, a pipe locking connection structure in accordance with the preferred embodiment of the present invention comprises a male pipe 1 and a female pipe 2 connected with the male pipe 1.

The male pipe 1 includes a male pipe body 11. The male pipe body 11 has an outside provided with a slideway 12 and a locking groove 13. The slideway 12 extends axially from one end toward the other end of the male pipe body 11. The locking groove 13 is connected to a distal end of the slideway 12. An angle is defined between the slideway 12 and the locking groove 13.

The female pipe 2 includes a female pipe body 21. The female pipe body 21 has an inside provided with a projection 22. The female pipe body 21 is mounted on the male pipe body 11, and the projection 22 is inserted through the slideway 12 and is locked into the locking groove 13.

In the preferred embodiment of the present invention, the male pipe body 11 of the male pipe 1 has a two-stage stepped shape and has a reduced section 111 with a smaller diameter. The slideway 12 and the locking groove 13 are formed in the reduced section 111. The female pipe body 21 is mounted on the reduced section 111 of the male pipe body 11.

In the preferred embodiment of the present invention, the angle between the slideway 12 and the locking groove 13 is a right angle.

In the preferred embodiment of the present invention, the female pipe body 21 of the female pipe 2 has an inner diameter equal to an outer diameter of the male pipe body 11 of the male pipe 1.

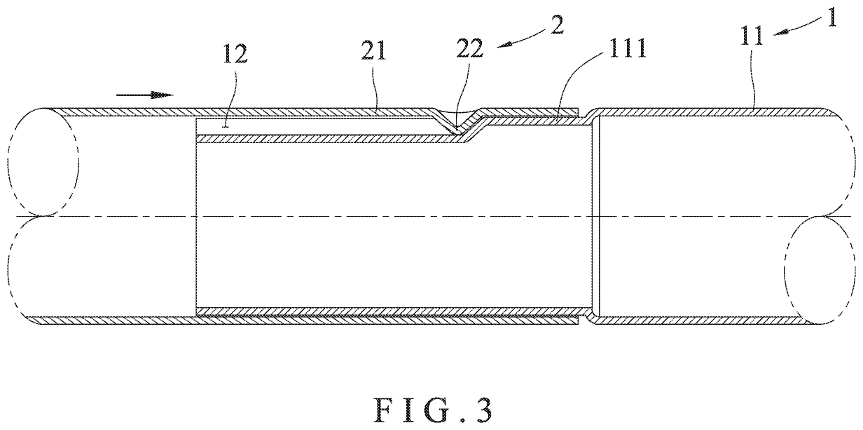

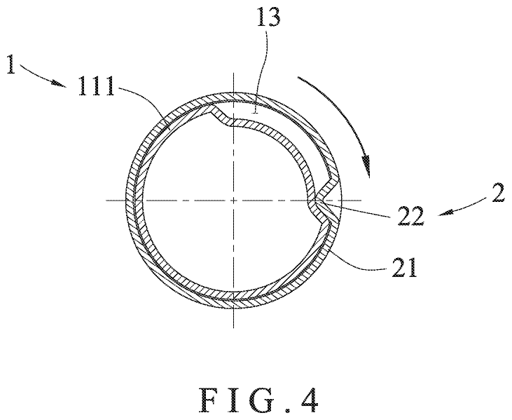

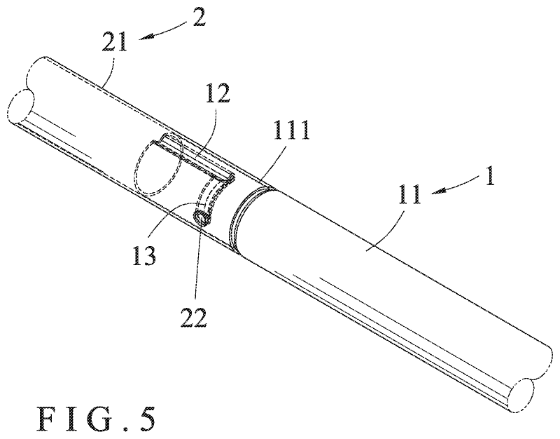

In assembly, referring to FIGS. 3-5 with reference to FIGS. 1 and 2, when the female pipe 2 is mounted on the male pipe 1, the female pipe body 21 is mounted on the reduced section 111 of the male pipe body 11, with the projection 22 aligning with the slideway 12. Then, the projection 22 is inserted through the slideway 12 until the projection 22 aligns with the locking groove 13. Then, the female pipe 2 is rotated relative to the male pipe 1, and the female pipe body 21 is rotated toward the locking groove 13, such that the projection 22 is inserted into and locked in the locking groove 13. Thus, the female pipe 2 is locked onto and affixed to the male pipe 1 without detachment.

On the contrary, the female pipe 2 is rotated relative to the male pipe 1 in the opposite direction, such that the projection 22 is moved from the locking groove 13 to the slideway 12. Then, the female pipe body 21 is pulled outward relative to the male pipe body 11, and the projection 22 is moved in the slideway 12, such that the female pipe 2 is detached from the male pipe 1.

In the preferred embodiment of the present invention, each of the male pipe 1 and the female pipe 2 is made of plastics or metal with elastic deforming capacity. The projection 22 has a width slightly larger than that of the locking groove 13, such that the projection 22 slightly presses the wall of the locking groove 13. Thus, the male pipe 1 and the female pipe 2 are fixedly connected and will not be loosened from each other. The user only needs to apply a force to detach the female pipe 2 from the male pipe 1.

Accordingly, the male pipe 1 and the female pipe 2 are assembled and disassembled easily and conveniently without needing aid of any hand tool. In addition, the male pipe 1 and the female pipe 2 are securely connected and detached simply and quickly. Further, the pipe locking connection structure is available for a coat hanger or an article shelf.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A pipe locking connection structure comprising:
a male pipe; and
a female pipe connected with the male pipe;
wherein:
the male pipe includes a male pipe body;
the male pipe body has an outside provided with a slideway and a locking groove;
the slideway extends from one end toward the other end of the male pipe body;
the locking groove is connected to a distal end of the slideway;
an angle is defined between the slideway and the locking groove;
the female pipe includes a female pipe body;
the female pipe body has an inside provided with a projection;
the female pipe body is mounted on the male pipe body; and
the projection is inserted through the slideway and is locked into the locking groove.

2. The pipe locking connection structure as claimed in claim 1, wherein the male pipe body of the male pipe has a two-stage stepped shape and has a reduced section with a smaller diameter, and the slideway and the locking groove are formed in the reduced section.

3. The pipe locking connection structure as claimed in claim 1, wherein the angle between the slideway and the locking groove is a right angle.
